(19) United States
(12) Patent Application Publication
(10) Pub. No.: US 2009/0175477 A1
(43) Pub. Date: Jul. 9, 2009

(54) Vibration transducer

(75) Inventors: Yukitoshi Suzuki, Hamamatsu-shi (JP); Toshihisa Suzuki, Hamamatsu-shi (JP); Kunimasa Muroi, Hamamatsu-shi (JP); Tatsuya Nagata, Hamamatsu-shi (JP)

Correspondence Address: PILLSBURY WINTHROP SHAW PITTMAN LLP, P.O BOX 10500, McLean, VA, 22102, US

(73) Assignee: Yamaha Corporation, Hamamatsu-shi (JP)

(21) Appl. No.: 12/228,589

(22) Filed: Aug. 14, 2008

(30) Foreign Application Priority Data
Aug. 20, 2007 (JP) 2007-213657

(51) Int. Cl. H04R 19/04

(52) U.S. Cl. 381/355

(57) ABSTRACT

A vibration transducer (e.g. a condenser microphone) having a high sensitivity is constituted of a housing composed of an airtight material having a through-hole, a vibration conversion die (e.g. a microphone die) which is attached to the interior surface of the housing at the prescribed position embracing the through-hole in plan view, and a barrier diaphragm composed of an airtight material whose external periphery is attached to the exterior surface of the housing in an airtight manner oppositely to the prescribed position. The barrier diaphragm has a vibration area which is larger than the sectional area of the through-hole. A space allowing the barrier diaphragm to vibrate is formed between the barrier diaphragm and the exterior surface of the housing, wherein the distance between the barrier diaphragm and the exterior surface of the housing can be gradually reduced from the vibration axis to the external periphery.

### BACKGROUND OF THE INVENTION

1. Field of the Invention

The present invention relates to vibration transducers and in particular to miniature vibration transducers such as condenser microphones serving as MEMS (Micro-Electro-Mechanical System) sensors.

The present application claims priority on Japanese Patent Application No. 2007-213657, the content of which is incorporated herein by reference.

2. Description of the Related Art

Conventionally, various types of miniature condenser microphones, which are manufactured by way of semiconductor device manufacturing processes, have been known and disclosed in various documents such as Patent Document 1 and Patent Document 2.

Patent Document 1: Japanese Unexamined Patent Application Publication No. 2001-78297

Patent Document 2: Japanese Unexamined Patent Application Publication No. 2004-537182

Through-holes for propagating sound waves are formed in the housing of miniature condenser microphones. In the condenser microphones disclosed in Patent Document 1 and Patent Document 2, the through-holes are closed with cloth and film composed of polytetrafluoroethylene and sintered metal. The cloth and film block light, humidity, and dust; hence, they improve the environmental resistance of condenser microphones.

The cloth (disclosed in Patent Document 1) does not block humidity. When the through-hole of the package is closed with the film composed of polytetrafluoroethylene or sintered metal as disclosed in Patent Document 2, the energy of sound waves transmitted through the film may be greatly damped, thus reducing the sensitivity of the condenser microphone.

### SUMMARY OF THE INVENTION

It is an object of the present invention to provide a miniature vibration transducer such as a condenser microphone, which is improved in environmental resistance without causing a sensitivity reduction.

A vibration transducer (e.g. a condenser microphone) of the present invention is constituted of a housing composed of an airtight material and having a through-hole, a vibration conversion die (e.g. a microphone die) which is attached to the interior surface of the housing in an airtight manner at the prescribed position embracing the through-hole in plan view, and a barrier diaphragm whose external periphery is attached to the exterior surface of the housing opposite to the prescribed position. The barrier diaphragm composed of an airtight material has a vibration area which is larger than the sectional area of the through-hole. In addition, a space allowing the barrier diaphragm to vibrate is formed between the barrier diaphragm and the exterior surface of the housing.

Since the vibration conversion die is closed with the housing and the barrier diaphragm in an airtight manner, it is possible to block humidity from the vibration conversion die. The aforementioned space allows the barrier diaphragm to vibrate between the barrier diaphragm and the exterior surface of the housing, whereby the barrier diaphragm relays very small waves and vibrations to the vibration conversion die arranged inside of the package. The sensitivity of the vibration transducer increases as the stiffness of a cavity formed between the barrier diaphragm and the vibration conversion die becomes higher. The stiffness of the cavity represents an elastic modulus of an elastic substance having a specific shape equivalently representing the medium (e.g. air) filling the cavity. It is preferable that the capacity of the space between the barrier diaphragm and the exterior surface of the housing be reduced as small as possible so as to allow the barrier diaphragm to vibrate therein. That is, it is preferable that the vibration conversion die be attached to the exterior surface of the housing so as to close the through-hole. For this reason, the vibration conversion die is attached to the interior surface of the housing at the prescribed position embracing the through-hole in plan view, wherein the opening area of the through-hole of the housing should be smaller than the bottom area of the vibration conversion die. When a film is extended across the through-hole having a constant sectional area as disclosed in Patent Document 2, the vibration area of the film becomes smaller than the bottom area of the vibration conversion die, wherein the film must be increased in rigidity. When waves and vibrations are relayed to the vibration conversion die by means of the film having a high rigidity, the sensitivity must be greatly degraded. The present invention is designed such that the external periphery of the barrier diaphragm is attached to the exterior surface of the housing at the prescribed position embracing the through-hole in plan view, wherein the vibration area of the barrier diaphragm is adequately larger than the sectional area of the through-hole of the housing. In contrast to the teaching of Patent Document 2 in which the vibration area of the film is substantially identical to the sectional area of the of the through-hole of the housing, the present invention allows the barrier diaphragm to easily vibrate with a high sensitivity to waves and vibrations occurring in the external space of the vibration transducer. In short, the present invention improves the environmental resistance of the miniature vibration transducer (or the miniature condenser microphone) without degrading the sensitivity thereof.

It is preferable that the distance between the barrier diaphragm and the exterior surface of the housing gradually decreases in the direction from the vibration axis to the external periphery of the barrier diaphragm. In the range of axially-symmetrical vibration, the displacement of the barrier diaphragm decreases in the direction from the vibration axis to the vibration-end terminal substantially corresponding to the external periphery of the barrier diaphragm. For this reason, by gradually reducing the distance between the barrier diaphragm and the exterior surface of the housing in the direction from the vibration axis to the external periphery of the barrier diaphragm, it is possible to reduce the capacity of the space between the barrier diaphragm and the vibration conversion die without reducing the amplitude of vibration of the barrier diaphragm.

It is preferable that at least one projection which projects from the exterior surface of the housing towards the barrier diaphragm be formed at the prescribed area of the exterior surface of the housing positioned opposite to the barrier diaphragm. Due to the formation of the projection which projects from the exterior surface of the housing towards the barrier diaphragm, it is possible to substantially prevent the barrier diaphragm from being adhered and fixed to the exterior surface of the housing even when a relatively high pressure (which may exceed the rated pressure) is applied to the barrier diaphragm which thus unexpectedly comes in contact with the exterior surface of the housing.

It is preferable that the housing and the vibration conversion die be subjected to a flip-chip connection established therebetween via a plurality of bumps forming a gap therebetween, which is sealed with a resin. Due to the flip-chip connection established between the housing and the vibration conversion die, it is possible to reduce the distance between the barrier diaphragm and the vibration conversion die, thus reducing the mount area of the vibration transducer mounted on a substrate or a circuit board of an electronic device. Since the gap between the bumps used in the flip-chip connection is sealed with a resin, it is possible to secure an airtight connection between the housing and the vibration conversion die.

It is preferable that the barrier diaphragm has an electromagnetic shield function, whereby it is possible to prevent the vibration conversion die from being substantially affected by electromagnetic noise, thus improving the S/N ratio of the vibration transducer.

It is preferable that the barrier diaphragm has an optical shield function, whereby it is possible to prevent the vibration conversion die from being substantially affected by optical noise, thus improving the S/N ratio of the vibration transducer.

It is preferable that the barrier diaphragm has water repellency, whereby it is possible to prevent water droplets from being unexpectedly attached to the barrier diaphragm.

It is preferable that the barrier diaphragm have a laminated structure constituted of a resin film and a metal film. Thus, it is possible to form the barrier diaphragm having flexibility and a shield function against electromagnetic waves and light.

It is preferable that the barrier diaphragm has a vibration area which is larger than the bottom area of the vibration transducer die.

It is preferable that the vibration area of the barrier diaphragm be substantially identical to the internal bottom area of the housing.

### BRIEF DESCRIPTION OF THE DRAWINGS

These and other objects, aspects, and embodiments of the present invention will be described in more detail with reference to the following drawings.

FIG. 1A is a longitudinal sectional view of a condenser microphone, which is a vibration transducer in accordance with a first embodiment of the present invention.

FIG. 1B is a horizontal sectional view of the condenser microphone.

FIG. 1C is a backside view of the condenser microphone, from which a barrier diaphragm is removed.

FIG. 2A is a longitudinal sectional view of the condenser microphone having a back cavity and a front cavity.

FIG. 2B is a circuit diagram showing an equivalent circuit representing the operation of the condenser microphone.

FIG. 3 is a longitudinal sectional view of a condenser microphone, which is a vibration transducer in accordance with a second embodiment of the present invention.

FIG. 4A is a longitudinal sectional view of a condenser microphone, which is a vibration transducer in accordance with a third embodiment of the present invention.

FIG. 4B is a horizontal sectional view of the condenser microphone from which a barrier diaphragm is removed.

FIG. 5 is a longitudinal sectional view of a condenser microphone, which is a vibration transducer in accordance with a fourth embodiment of the present invention.

FIG. 6 is a longitudinal sectional view of a condenser microphone, which is a vibration transducer in accordance with a fifth embodiment of the present invention.

FIG. 7 is a longitudinal sectional view of a vibration transducer in accordance with a sixth embodiment of the present invention.

FIG. 8 is a longitudinal sectional view showing the structure of a condenser microphone of a comparative example used for simulation.

FIG. 9A is a longitudinal sectional view showing a condenser microphone in accordance with a seventh embodiment of the present invention.

FIG. 9B is a plan view showing the bottom of the housing of the condenser microphone shown in FIG. 9A, which arranges external terminals in relation to a seal ring.

FIG. 9C is a longitudinal sectional view showing that the condenser microphone of FIG. 9A is mounted on a device substrate for use in an electronic device.

FIG. 10A is a longitudinal sectional view showing a condenser microphone in accordance with an eighth embodiment of the present invention.

FIG. 10B is a plan view showing the bottom of the housing of the condenser microphone shown in FIG. 10A.

FIG. 10C is a plan view showing the bottom of the housing of the condenser microphone of FIG. 10A, from which a barrier diaphragm is excluded so as to show external terminals in relation to a seal ring.

### DESCRIPTION OF THE PREFERRED EMBODIMENTS

The present invention will be described in further detail by way of examples with reference to the accompanying drawings, wherein parts identical to those shown in the foregoing drawings are designated by the same reference numerals.

### 1. First Embodiment

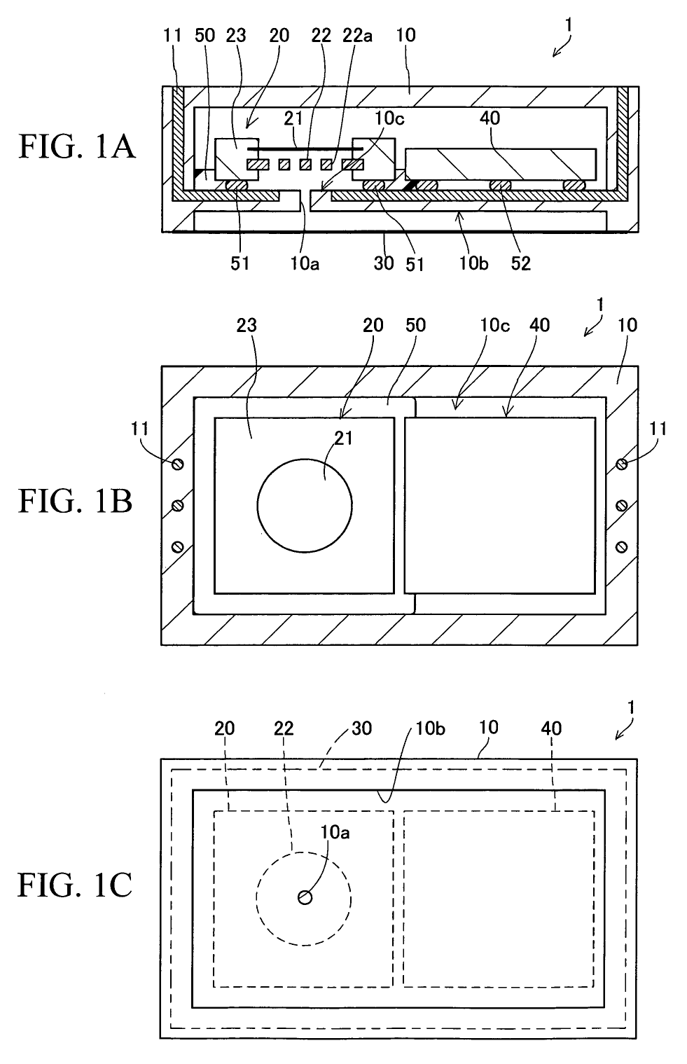

FIG. 1A is a longitudinal sectional view of a vibration transducer, i.e. a condenser microphone 1 in accordance with a first embodiment of the present invention. FIG. 1B is a horizontal sectional view of the condenser microphone 1. FIG. 1C is a backside view of the condenser microphone 1, from which a barrier diaphragm 30 is removed.

The condenser microphone 1 of the first embodiment is a miniature condenser microphone serving as an MEMS sensor, which is installed in a portable electronic device such as a cellular phone. Specifically, the condenser microphone 1 is constituted of a microphone die 20 serving as a vibration conversion die, an amplifier die 40, and a housing 10 for storing them as well as the barrier diaphragm 30 for covering a through-hole 10a of the housing 10.

The housing 10 has a box-like shape forming a space for storing the microphone die 20 and the amplifier die 40. Housing 10 is composed of an airtight material, which is selected from among ceramics, metals, and heat-resistant resins. For example, a main unit of the housing 10 is formed in a box-like shape having no cover by combining a ceramic sheet with wiring elements 11 such as plane wires, connection pads, and through-wires and is then combined with a cover composed of a heat-resistant resin, thus completely forming the housing 10. Due to the formation of the through-hole 10a of the housing 10, pressure of the external space of the housing 10 is applied to the internal space of the housing 10 via the through-hole 10a of the housing 10. The through-hole 10a has a very low acoustic resistance with respect to sound waves of an audio frequency range. The housing 10 does not substantially transmit sound waves therethrough.

The external periphery of the barrier diaphragm 30 is attached to the exterior surface of the housing 10 at a prescribed position embracing the through-hole 10a in plan view. Materials, dimensions, shapes, and tension of the barrier diaphragm 30 are determined such that the resonance frequency of the barrier diaphragm 30 becomes higher than the audio frequency range of sound waves. The barrier diaphragm 30 is composed of an airtight non-transparent material. For this reason, the internal space of the housing 10 is isolated from the external space with respect to water droplets, humidity, dust, and light. The barrier diaphragm 30 is attached to the housing 10 in an airtight manner by way of thermal pressing bonding and caulking. Specifically, the barrier diaphragm 30 is composed of water-repellent fluorine-contained resins such as PTFE (polytetrafluoroethylene) and PFA (tetrafluoroethylene-perfluoroalkylvinylether copolymer), heat-resistant resins such as polyimide, and metals having electromagnetic shield functions such as aluminum and nickel as well as laminated structures of these materials. When the barrier diaphragm 30 has an electromagnetic shield function, a metal film is grounded via the wiring elements 11 of the housing 10. When the barrier diaphragm 30 is composed of resins, it is possible to apply superior vibration characteristics and flexibility to the barrier diaphragm 30. When the surface of the barrier diaphragm 30 has water repellency, it is possible to prevent water droplets and corrosive substances (that may exist in water droplets) from being attached to the barrier diaphragm 30. When the barrier diaphragm 30 has an electromagnetic shield function, it is possible to improve the S/N ratio of the microphone die 20 having a high-impedance output. In order to apply all the aforementioned properties to the barrier diaphragm 30, it is preferable to form the barrier diaphragm 30 in the laminated structure.

The external periphery of the barrier diaphragm 30 is attached to a peripheral projection of the housing 10, which is formed in the surrounding area of the through-hole 10a. Thus, it is possible to form a space, which allows the barrier diaphragm 30 to vibrate, between the barrier diaphragm 30 and the exterior surface of the housing 10. Herein, the joint boundary between the external periphery of the barrier diaphragm 30 and the housing serves as a vibration-end terminal; that is, the internal area of the barrier diaphragm 30 from the vibration-end terminal is a vibration area of the barrier diaphragm 30.

The microphone die 20 is bonded onto the interior surface of the housing 10 at a prescribed position embracing the through-hole 10a in plan view. The microphone die 20 has an MEMS structure constituted of a substrate composed of monocrystal silicon and deposited films. Gaps due to bumps 51 establishing flip-chip connection between the microphone die 20 and the housing 10 are sealed with a resin 50; hence, the microphone die 20 joins the interior surface of the housing 10 in an airtight manner. The microphone die 20 is constituted of an electrode diaphragm 21 and an electrode plate 22, which are composed of deposited conductive films composed of polysilicon doped with impurities and metals. The electrode diaphragm 21 and the electrode plate 22 are supported by a support 23 having a rectangular shape whose lower end joins the interior surface of the housing 10 and are thus positioned in parallel with each other with small distance (e.g. 4 μm) therebetween. Although a plurality of holes 22a is formed in the electrode plate 22, the rigidity of the electrode plate 22 is adequately higher than the rigidity of the electrode diaphragm 21. The holes 22a of the electrode plate 22 have acoustic resistances, which are very low with respect to sound waves of the audio frequency range. The resonance frequency of the electrode diaphragm 21 is higher than the audio frequency range of sound waves.

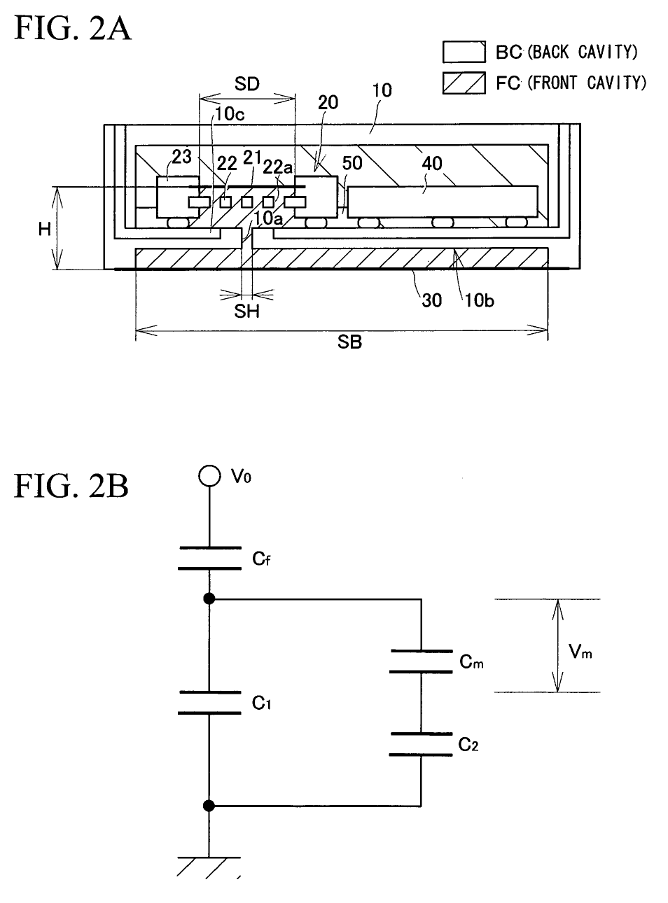

The internal space of the condenser microphone 1 is partitioned by the electrode diaphragm 21 and the support 23 in terms of acoustics. As shown in FIG. 2A, the space defined between the barrier diaphragm 30 and an exterior surface 10b of the housing 10 (in its backside), the space of the through-hole 10a, and the internal space of the microphone die 20 form a single space (referred to as a front cavity FC) in terms of acoustics, while a part of the internal space of the housing 10 external of the microphone die 20 forms another space (referred to as a back cavity BC) in terms of acoustics, wherein these two spaces are partitioned by the electrode diaphragm 21 and the support 23. The front cavity FC communicates with the back cavity so as to establish a balance with regard to static pressure; that is, these two spaces are connected together via a narrow passage having an adequately high acoustic resistance with respect to sound waves of the audio frequency range. This passage is laid between the support 23 and the electrode diaphragm 21, or it is formed using a through-hole (not shown) formed in the support 23, for example.

The amplifier die 40 having the CMOS circuitry includes a pre-amplifier for amplifying voltage variations representing capacitance variations between the electrode diaphragm 21 and the electrode plate 22 and a charge pump for applying a bias voltage to the electrode diaphragm 21 and the electrode plate 22. The amplifier die 40 is subjected to flip-chip connection with the interior surface of the housing 10 via bumps 52.

Next, the operation of the condenser microphone 1 will be described with reference to FIGS. 2A and 2B.

A bias voltage is applied to the electrode diaphragm 21 and the electrode plate 22, which thus forms a parallel-plate condenser. The barrier diaphragm 30 vibrates in response to sound waves of a prescribed frequency range. The vibration of the barrier diaphragm 30 causes pressure variations in the front cavity FC. Since the front cavity FC is a very small acoustically closed space in the audio frequency range; hence, the internal pressure of the front cavity FC is applied to the electrode diaphragm 21 with the same phase. That is, when sound waves, which are external pressure variations of the condenser microphone 1, reach the electrode diaphragm 21, the electrode diaphragm 21 vibrates so that the capacitance of the parallel-plate condenser is varied. Capacitance variations are converted into electric signals, which are then amplified in the amplifier die 40; hence, amplified electric signals are output to a substrate (or a circuit board for mounting the condenser microphone 1, not shown) via the wiring elements 11.

It is presumed that the electrode diaphragm 21 is driven by way of stiffness control. Due to a very small internal space of the condenser microphone 1, it is presumed that the response of the vibration system may depend upon the stiffness of mechanical elements such as films, media, and partitions of a closed space in the low frequency range that is lower than the resonance frequency. That is, as a ratio of the stiffness of the front cavity FC against the stiffness of the back cavity BC becomes higher, it is possible to efficiently transmit sound pressures to the electrode diaphragm 21.

The mechanical elements of the condenser microphone 1 can be replaced with the following elements regarding electricity and physics and are thus represented by an equivalent circuit shown in FIG. 2B.

Stiffness of the barrier diaphragm 30: 1/C_{f}

Stiffness of the front cavity FC: 1/C₁

Stiffness of the electrode diaphragm 21: 1/Cₘ

Stiffness of the back cavity BC: 1/C₂

External sound pressure of the condenser microphone 1: Vo

Sound pressure applied to the electrode diaphragm 21: Vm

The equivalent circuit of FIG. 2B clearly shows that the sound pressure Vm applied to the electrode diaphragm 21 can be increased by increasing the capacitances C_{f} and C₂ while decreasing the capacitance C₁. That is, it is possible to increase the sound pressure Vm applied to the electrode diaphragm 21 by decreasing the stiffness of the barrier diaphragm 30, the stiffness of the electrode diaphragm 21, and the stiffness (of the medium) of the back cavity BC while increasing the stiffness (of the medium) of the front cavity FC; thus, it is possible to improve the sensitivity of the condenser microphone 1.

The stiffness of the back cavity BC is calculated by dividing the force applied to the electrode diaphragm 21 by the displacement of the electrode diaphragm 21. The stiffness of the front cavity FC is calculated by dividing the force applied to the barrier diaphragm 30 by the displacement of the barrier diaphragm 30. The following calculations are established under the presumption that a force is applied to a diaphragm corresponding to the bottom of a cylindrical cavity, wherein it is possible to calculate the stiffness k of the cavity by use of the radius r of the diaphragm, the volume V of the cavity, the area S of the diaphragm, the displacement Δx of the diaphragm, the pressure P applied to the diaphragm, and volume variations ΔV of the cavity.

$$\begin{matrix}k = \frac{PS}{Δ x} & ( 1 ) \\ Δ V = S Δ x & ( 2 )\end{matrix}$$

An equation (3) is produced based on the equations (1) and (2).

$$\begin{matrix}k = \frac{{PS}^{2}}{Δ V} & ( 3 ) \\ S = π {r}^{2} & ( 4 )\end{matrix}$$

By way of the equations (3) and (4), it is possible to produce the stiffness k of the cavity as follows:

$$k = \frac{P {π}^{2} {r}^{4}}{Δ V}$$

That is, the stiffness of the cavity varies in proportion to the term “r⁴/ΔV” in the above equation. Since the air (corresponding to the medium of the cavity) has a constant elastic modulus, the volume variations ΔV of the cavity are proportional to the volume V of the cavity.

According to the aforementioned calculation results, it is preferable that the volume of the front cavity FC be further reduced, the radius of the barrier diaphragm 30 be further increased, and the volume of the back cavity BC be further increased. In order to reduce the volume of the front cavity FC, it is necessary that the microphone die 20 be attached to the interior surface of the housing 10 having the through-hole 10a in an airtight manner while reducing a distance H (see FIG. 2A) between the barrier diaphragm 30 and the electrode diaphragm 21. In order to reduce the distance H between the barrier diaphragm 30 and the electrode diaphragm 21, it is preferable to attach the microphone die 20 to the housing in a flip-chip connection manner. In order to increase the volume of the back cavity BC, it is necessary to determine the arrangement of the regions filled with the resin 50, the microphone die 20, and the amplifier die 40 in such a way that a large part of the internal space of the housing 10 external to the microphone die 20 can be used for the back cavity BC as large as possible.

It is possible to reduce the volume of the front cavity FC by reducing a vibration area SB of the barrier diaphragm 30 and a vibration area SD of the electrode diaphragm 21 (see FIG. 2A), whereas both the barrier diaphragm 30 and the electrode diaphragm 21 are increased in stiffness. Generally speaking, the stiffness of an elastic film is inversely proportional to the area of the elastic film when flexural rigidity is a dominant factor, while it is proportional to the tensile stress of the elastic film when tension is a dominant factor. In order to reduce the stiffness of the barrier diaphragm 30, it is necessary to increase the area of the barrier diaphragm 30 while reducing the tensile stress applied to the barrier diaphragm 30. For this reason, the present embodiment is not designed such that the barrier diaphragm 30 joins the inside or the opening of the through-hole 10a of the housing 10 but is designed such that the external periphery of the barrier diaphragm 30 joins the peripheral projection of the housing 10 (in its backside) at the prescribed position embracing the through-hole 10a in plan view. In the present embodiment, the vibration area SB of the barrier diaphragm 30 is larger than the sectional area of the through-hole 10a and the bottom area of the microphone die 20 but is substantially identical to the internal bottom area of the housing 10.

Simulations are performed on the present embodiment in comparison with a comparative example of a condenser microphone shown in FIG. 8, wherein compared with the condenser microphone 1 shown in FIG. 1, the housing 10 is replaced with a housing 15 whose backside is not attached with the barrier diaphragm 30 and in which the through-hole 10a is replaced with a through-hole 15a formed on the top portion and covered with a barrier diaphragm 32, and wherein the microphone die 20 is replaced with a microphone die 24 in which the electrode diaphragm 21 is positioned below the electrode plate 22. The results of simulations are shown in Table 1 with regard to the following parameters, wherein a sensitivity reduction of the comparative example is measured based on the sensitivity of the condenser microphone of FIG. 8 from which the barrier diaphragm 32 is removed, and a sensitivity reduction of the present embodiment is measured based on the sensitivity of the condenser microphone 1 from which the barrier diaphragm 30 is removed.

Material of the barrier diaphragm: PFA

Young's modulus of the barrier diaphragm: 680 MPa

Density of the barrier diaphragm: 2170 kg/m³

Tensile stress of the barrier diaphragm: 0.1 MPa

r: radius of the barrier diaphragm

v: volume of the front cavity

h: distance between the exterior surface of the housing and the barrier diaphragm

sf: stiffness of the barrier diaphragm

sl: stiffness of the front cavity

sm: stiffness of the electrode diaphragm

s2: stiffness of the back cavity

TABLE 1

| | | | | | | | | Sensitivity |
|---|---|---|---|---|---|---|---|---|
| | r | v | h | Sf | s1 | sm | s2 | Reduction |
| Unit | mm | mm³ | Mm | N/m | N/m | N/m | N/m | dB |
| Compar- | 0.35 | 3.5 | — | 270 | 0.7 | 25 | 25 | −58 |
| ative | | | | | | | | |
| Example | | | | | | | | |
| Present | 1.4 | 1.2 | 0.2 | 24 | 500 | 25 | 2.8 | −6.6 |
| Embodi- | | | | | | | | |
| ment | | | | | | | | |

The pressure of the internal space of the condenser microphone 1, which is tightly closed with the barrier diaphragm 30 increases when the condenser microphone 1 is mounted on a substrate (or a circuit board, not shown) by way of a solder reflow process. However, due to the flexibility of the barrier diaphragm 30 and the relatively large vibration area of the barrier diaphragm 30 (which is larger than the vibration area of the electrode diaphragm 21), it is unlikely that the barrier diaphragm 30 is unexpectedly destroyed due to tensile stress occurring in the solder reflow process. The back cavity BC, which is tightly closed by the electrode diaphragm 21, which is very small compared with the barrier diaphragm 30 in terms of acoustics, may communicate with the front cavity FC with respect to static pressure. For this reason, even when the pressure of the internal space of the condenser microphone 1 increases in the solder reflow process, the tensile stress of the electrode diaphragm 21 is unlikely to increase.

### 2. Second Embodiment

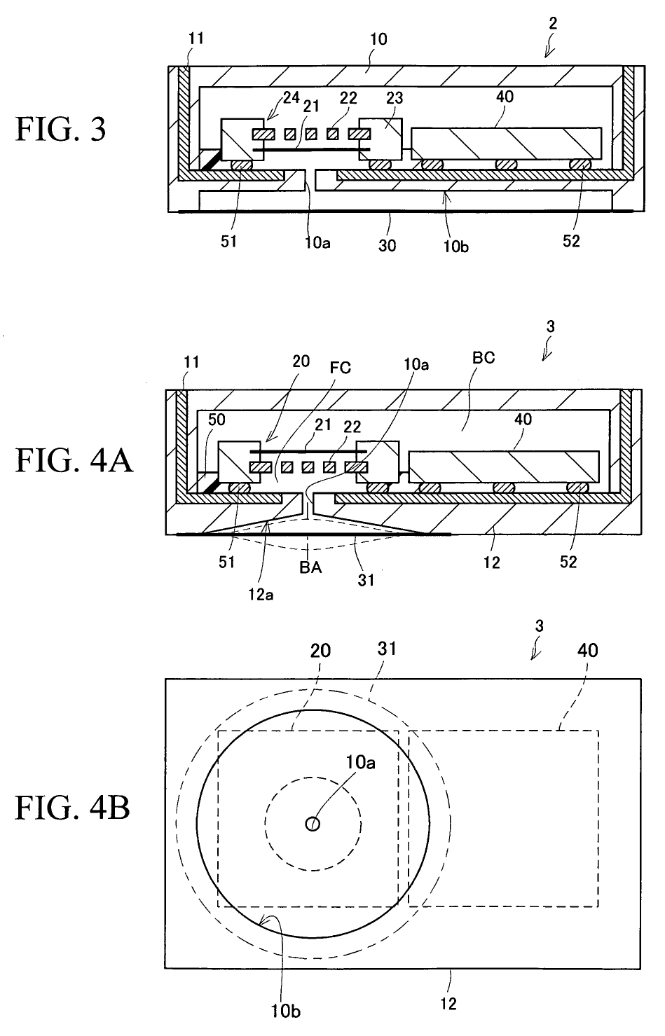

FIG. 3 is a longitudinal sectional view of a condenser microphone 2, which is a vibration transducer in accordance with a second embodiment of the present invention. Herein, the electrode diaphragm 21 is positioned below the electrode plate 22 and close to the barrier diaphragm 30.

### 3. Third Embodiment

FIG. 4A is a longitudinal sectional view of a condenser microphone 3, which is a vibration transducer in accordance with a third embodiment of the present invention. FIG. 4B is a horizontal sectional view of the condenser microphone 3 from which a barrier diaphragm 31 is removed from the backside.

Generally speaking, it is preferable that the gap between the barrier diaphragm and the exterior surface of the housing be minimized in conformity with vibration of the barrier diaphragm. In the third embodiment, the diaphragm 31 is positioned to tightly close a conical recess (or a tapered recess) of a housing 12 (having the through-hole 10a). The barrier diaphragm 31 has an axially symmetrical vibration mode in a lower frequency range lower than the resonance frequency thereof. That is, the amplitude of the barrier diaphragm 31 becomes small in a direction from a vibration axis BA (substantially corresponding to the center of the barrier diaphragm 31) to a vibration-end terminal (substantially corresponding to the external periphery of the barrier diaphragm 31). For this reason, it may be difficult for the external periphery of the barrier diaphragm 31 to come in contact with an exterior surface 12a of the housing 12 irrespective of a short distance between the barrier diaphragm 31 and the housing 12. That is, the condenser microphone 3 of the third embodiment is designed such that a conical recess is formed in the exterior surface 12a of the housing 12 so as to gradually reduce the distance between the barrier diaphragm 31 and the exterior surface 12a of the housing in the direction from the vibration axis BA to the vibration-end terminal (substantially corresponding to the external periphery of the barrier diaphragm 31). Compared with the foregoing condenser microphone in which the constant distance is provided between the barrier diaphragm 31 and the exterior surface 12a of the housing 12 with respect to the area in which the barrier diaphragm 31 is positioned opposite to the exterior surface 12a of the housing 12, the condenser microphone 3 can reduce the volume of the front cavity FC so as to further improve the sensitivity thereof.

### 4. Fourth Embodiment

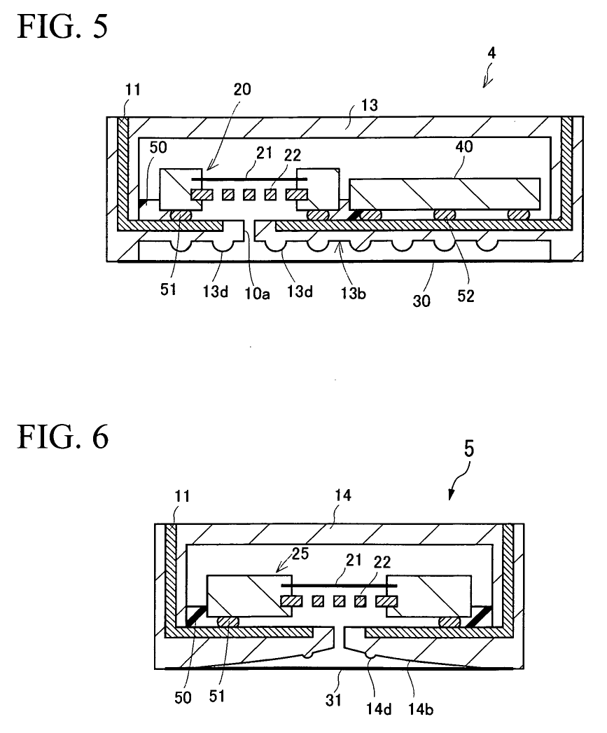

FIG. 5 is a longitudinal sectional view of a condenser microphone 4, which is a vibration transducer in accordance with a fourth embodiment of the present invention. Compared with the condenser microphone 1, the condenser microphone 4 has a housing 13 having the through-hole 10a covered with the barrier diaphragm 30. In order for the barrier diaphragm 30 to come in contact with an exterior surface 13b of the housing 13, a plurality of projections 13d is formed on the exterior surface 13b of the housing 13, which is positioned opposite to the barrier diaphragm 30. Instead, only a single projection 13d can be formed at a prescribed area of the exterior surface 13b of the housing 13, which may easily come in contact with the barrier diaphragm 30 with a relatively high probability. That is, the number and position of the projection(s) 13d may be optimally determined based on the property and dimensions of the barrier diaphragm 30.

### 5. Fifth Embodiment

FIG. 6 is a longitudinal section view of a condenser microphone 5, which is a vibration transducer in accordance with a fifth embodiment of the present invention. FIG. 6 shows that only a microphone die 25 is installed in a housing 14, wherein the microphone die 25 can be equipped with an MEMS structure and its drive circuitry and output circuitry; in other words, the microphone die 25 can be equipped with the CMOS circuitry (not shown) having the aforementioned charge pump and pre-amplifier. Since a single microphone die 25 is installed in the housing 14, it is possible reduce the bottom area of the condenser microphone 5. The housing 14 has a conical recess, which is covered with a barrier diaphragm 31 in such a way that the distance between an exterior surface 14b of the housing 14 and the barrier diaphragm 31 gradually decreases in a direction from the vibration axis (substantially corresponding to the center of the barrier diaphragm 31) to the vibration-end terminal (substantially corresponding to the external periphery of the barrier diaphragm 31). In addition, projections 14d, which project downwardly from the exterior surface 14b to the barrier diaphragm 31, are formed at prescribed positions of the exterior surface 14b of the housing 14.

### 6. Sixth Embodiment

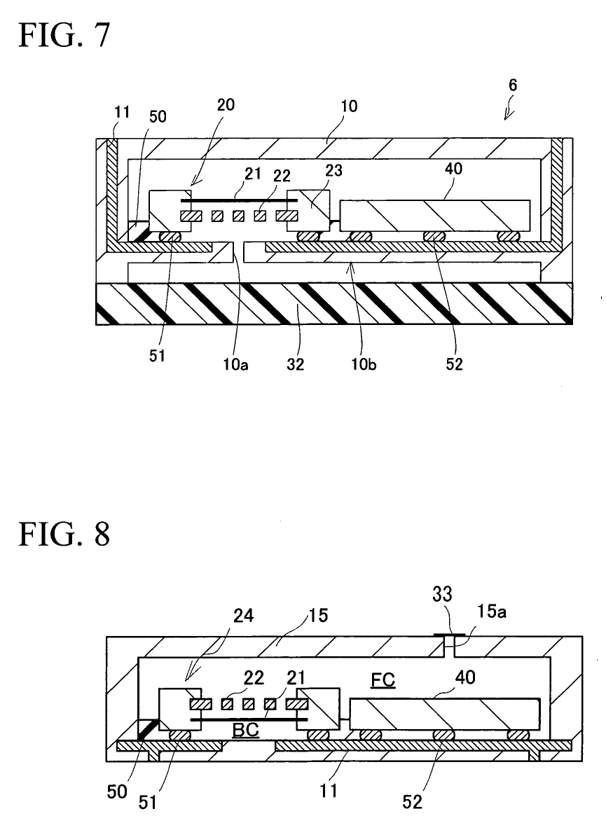

FIG. 7 is a longitudinal sectional view of a a vibration transducer 6 in accordance with a sixth embodiment of the present invention. The vibration transducer 6 is basically identical to the condenser microphone 1 except that the barrier diaphragm 30 is replaced with a barrier diaphragm 32, which is a thick elastic film whose stiffness is dominated by flexure rigidity. The vibration transducer 6 is suitable for use in monitoring variations of mechanical vibration, which are converted into variations of electric signals, such as contact-type sensors.

### 7. Seventh Embodiment

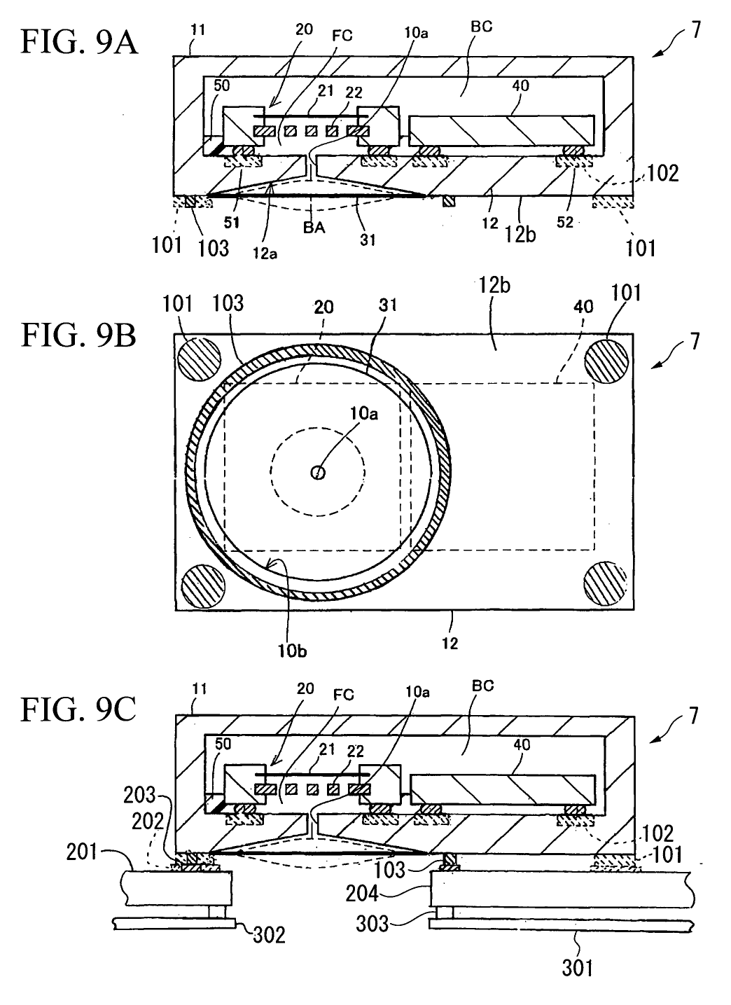

Next, a seventh embodiment of the present invention will be described with reference to FIGS. 9A to 9C, which show a condenser microphone 7 serving as the vibration transducer of the seventh embodiment. FIG. 9A is a longitudinal sectional view of the condenser microphone 7 perpendicular to the electrode diaphragm 21. FIG. 9B is a plan view of the condenser microphone 7 in parallel with the electrode diaphragm 21, in which the barrier diaphragm 31 is excluded in the illustration.

The condenser microphone 7 has a plurality of external terminals 101, which is electrically connected to a plurality of internal terminals 102 via internal wirings (not shown). In addition, the condenser microphone 7 has a ring-shaped seal ring 103 composed of a conductive material, which is positioned in the periphery of the barrier diaphragm 31. Both the external terminals 101 and the seal ring 103 are exposed externally of a bottom 12b of the housing 12 forming the barrier diaphragm 31, wherein they are composed of conductive materials such as solders. The external terminals 101 are each formed in a circular shape in plan view and are positioned at the four corners of the bottom 12b of the housing 12. The seal ring 103 is arranged in the bottom 12b of the housing 12 so as to surround the barrier diaphragm 31 and is formed with a prescribed height substantially matching the heights of the external terminals 101.

FIG. 9C is a longitudinal sectional view showing that the condenser microphone 7 is mounted on a device substrate 201 for mounting electronic components and is electrically connected to printed circuits of the device substrate 201. Specifically, the external terminals 101 are electrically connected to a printed-circuit pattern 202, while the seal ring 103 is electrically connected to a ring-shaped printed-circuit pattern 203.

A through-hole 204 is formed to run through the device substrate 201 at the inner area of the printed-circuit pattern 203. The device substrate 201 mounting electronic components is stored in a housing 301 forming the exterior surface of an electronic device such as a cellular phone. The housing 301 has an opening 302 communicating with the through-hole 204. The opening 302 and the through-hole 204 are interconnected together in an airtight manner via a packing 303, while the through-hole 204 and the barrier diaphragm 31 are interconnected together in an airtight manner when the seal ring 103 is soldered to the printed-circuit pattern 203.

Pressure variations corresponding to sound waves entering into the housing 301 from the external space are introduced into the opening 302 and then propagate through the space defined by the packing 303, through-hole 204, the printed-circuit pattern 203, and the seal ring 103, thus forcing the barrier diaphragm 31 to vibrate. The vibration of the barrier diaphragm 31 causes the vibration of the electrode diaphragm 21 of the microphone die 24.

### 8. Eighth Embodiment

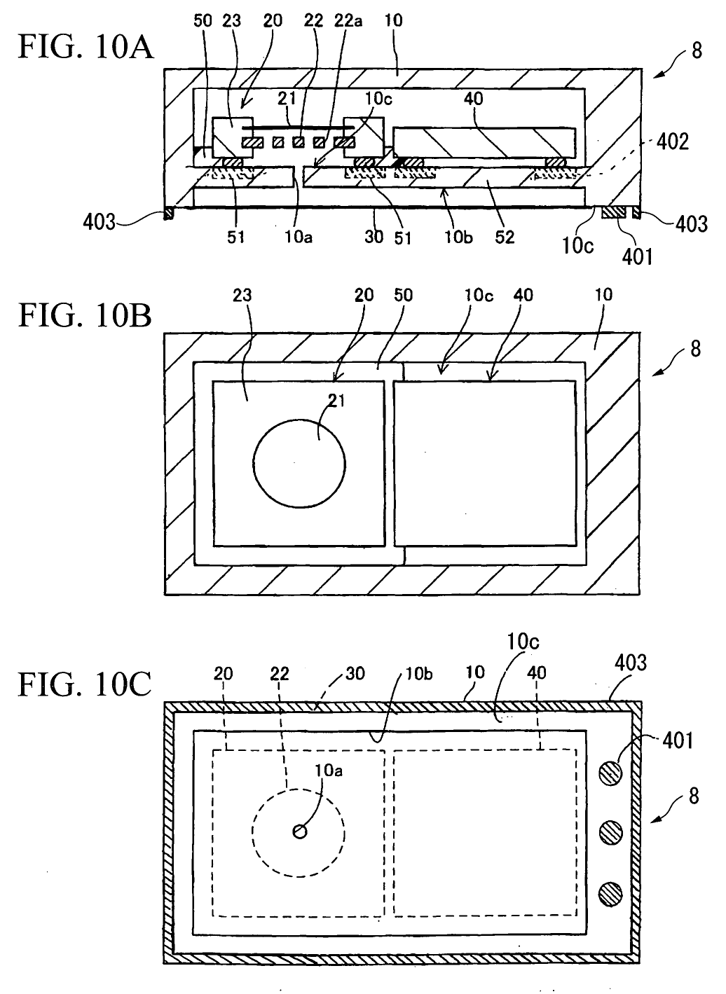

Next, an eighth embodiment of the present invention will be described with reference to FIGS. 10A to 10C, which shows a condenser microphone 8 serving as a vibration transducer of the eight embodiment. FIG. 10A is a longitudinal sectional view of the condenser microphone 8 perpendicular to the electrode diaphragm 21. FIG. 10B is a plan view of the condenser microphone 8 in parallel with the electrode diaphragm 21. FIG. 10C is a plan view of the condenser microphone 8 perpendicular to the electrode diaphragm 21, in which the barrier diaphragm 30 is excluded in the illustration.

The condenser microphone 8 has a plurality of external terminals 401, which is electrically connected to a plurality of internal terminals 402 via internal wirings (not shown). The condenser microphone 8 has a rectangular-shaped seal ring 403 composed of a conductive material. Both the external terminals 401 and the seal ring 403 are exposed externally of a bottom 10c of the housing 10 forming the barrier diaphragm 30 and are composed of conductive materials such as solders. The external terminals 401 are each formed in a circular shape in plan view and are collectively aligned along one side of the bottom 10c of the housing 10. The seal ring 403 is positioned on the bottom 10c of the housing 10 so as to surround the barrier diaphragm 30 and the external terminals 401, wherein it is formed with a prescribed height substantially matching the heights of the external terminals 401.

Similar to the condenser microphone 7, the condenser microphone 8 can be easily mounted on a device substrate having a through-hole (not shown). Since the seal ring 403 is formed on the bottom 10c of the housing 10 so as to surround the barrier diaphragm 30 and the external terminals 401, it is possible to increase the size of the through-hole and to adequately introduce pressure variations (corresponding to sound waves produced in the external space) into the condenser microphone 8.

The present invention is not necessarily limited to the first to eighth embodiments, which can be further modified in material, dimension, and shape within the scope of the invention as defined in the appended claims. Of course, it is possible to redesign the condenser microphone and vibration sensor by appropriately reducing the constituent elements thereof or by adding new constituent elements which are design choices for those having ordinary skill in the art.

What is claimed is:

1. A vibration transducer comprising:
a housing composed of an airtight material and having a through-hole;
a vibration conversion die which is attached to an interior surface of the housing in an airtight manner at a first position embracing the through-hole in plan view; and
a barrier diaphragm whose external periphery is attached to an exterior surface of the housing at a second position vertically matching the first position for embracing the through-hole in plan view, wherein the barrier diaphragm composed of an airtight material has a vibration area which is larger than a sectional area of the through-hole,
wherein a space allowing the barrier diaphragm to vibrate is formed between the barrier diaphragm and the exterior surface of the housing.

2. A vibration transducer according to claim 1, wherein a distance between the barrier diaphragm and the exterior surface of the housing gradually decreases in a direction from a vibration axis of the barrier diaphragm to the external periphery of the barrier diaphragm.

3. A vibration transducer according to claim 1, wherein at least one projection which projects from the exterior surface of the housing towards the barrier diaphragm is formed at a prescribed area of the exterior surface of the housing positioned opposite to the barrier diaphragm.

4. A vibration transducer according to claim 1, wherein the housing and the vibration conversion die are subjected to a flip-chip connection established therebetween via a plurality of bumps forming a gap therebetween, which is sealed with a resin.

5. A vibration transducer according to claim 1, wherein the barrier diaphragm has an electromagnetic shield function.

6. A vibration transducer according to claim 1, wherein the barrier diaphragm has an optical shield function.

7. A vibration transducer according to claim 1, wherein the barrier diaphragm has water repellency.

8. A vibration transducer according to claim 1, wherein the barrier diaphragm has a laminated structure constituted of a resin film and a metal film.

9. A vibration transducer according to claim 1, wherein the barrier diaphragm has a vibration area which is larger than a bottom area of the vibration transducer die.

10. A vibration transducer according to claim 1, wherein the barrier diaphragm has a vibration area which is substantially identical to an internal bottom area of the housing.
